(19) United States
(12) Patent Application Publication
(10) Pub. No.: US 2025/0002207 A1
(43) Pub. Date: Jan. 2, 2025

(54) PAPERBOARD-BASED CONTAINER

(71) Applicant: Elopak ASA, SPIKKESTAD (NO)

(72) Inventors: Anders Stralin, Torslanda (SE); Mikael Lennart Jansson, Drammen (NO); Fredrik Skaug, Gullaug (NO)

(73) Assignee: Elopak ASA, SPIKKESTAD (NO)

(21) Appl. No.: 18/704,946

(22) PCT Filed: Oct. 28, 2022
(86) PCT No.: PCT/EP2022/080275

§ 371 Date: Apr. 26, 2024

(30) Foreign Application Priority Data
Oct. 29, 2021 (NO) 20211308

(51) Int. Cl. B65D 5/56; B32B 3/26; B32B 27/08; B32B 27/10; B32B 27/30; B32B 27/32; B65D 5/74

(52) U.S. Cl. CPC B65D 5/563; B32B 3/266; B32B 27/08; B32B 27/10; B32B 27/306; B32B 27/32; B65D 5/748; B32B 2255/10; B32B 2307/72; B32B 2307/7246; B32B 2439/62; B32B 2439/70

(57) ABSTRACT

A container for holding a pourable food product, the container comprising a laminated packaging sheet material which is folded to form said container, the packaging sheet material being suitable for use with a half-cut opening arrangement.

### FIELD OF THE INVENTION

The present disclosure relates to a paperboard-based container for holding a pourable food product, the container comprising a laminate packaging sheet material which is folded to form said container.

### BACKGROUND

Within the art of paperboard-based packaging, it is known to produce a blank which is folded and assembled to produce a container. The container may then be utilised to hold a pourable food product, e.g. a liquid, e.g. dairy products, such as milk or yoghurt, or juices.

The blank is typically produced from a laminate packaging material, which typically comprises a multi-ply paperboard sheet on which is laminated one or a plurality of barrier layers for holding the food product and/or prevent migration of air and flavours through the paperboard. A barrier layer may typically comprise an aluminium foil.

A method of producing the blank from the laminate packaging material typically comprises the steps of cutting the laminate packaging material to a predefined shape, and a method of producing the container from the blank typically comprises the step of folding the blank along predefined folding lines to produce the container.

The blank may be provided with crease lines in the laminate packaging material to aid folding of the blank along the folding lines. A crease line, or crease, may be defined as an embossed or impressed depression on one side of the laminate packaging material with a corresponding raised ridge or welt, also referred to as the bead, on the other side forming a line along which the laminate packaging material is structurally weakened and along which the laminate packaging material will bend or fold when pressure is applied.

Alternatively, a paperboard-based container may be produced in a roll-fed process in which a continuous web of laminate packaging material is fed to a filling machine, folded and sealed longitudinally to form a tube. The tube is then filled with the pourable food product, sealed and cut transversally to form so called pouches. The pouches are than provided with an opening device and manipulated to obtain its final, gable-top form. Said manipulation typically involves folding down and securing gable sections of the container to side panel section of the same.

The container may be provided with an opening arrangement allowing a consumer to open the container to access the food product. In the prior art, it is known to use plastic opening arrangements, such as arrangements comprising plastic pour spouts and lid portions. A particular advantageous opening arrangement for such containers is based on the known half-cut method. Details of the half-cut method are disclosed in EP1786618B1. The major advantage of the half-cut method is that the barrier layer is fully intact until the container is opened by an end user. Another advantage of the half-cut method during production is that the laminate may initially be produced as a homogenous sheet without any cutouts. In similar methods for obtaining an opening having an intact barrier layer, the paperboard is provided with openings before lamination and at least the barrier layer is subsequently laminated over the paperboard including the openings.

Recent progress in the field of paperboard-based containers have seen the replacement of the commonly used aluminium foil by alternative barrier layers more suitable for recycling. The alternative barrier layers may be a polymeric barrier layer e.g. comprise a layer of ethylene vinyl alcohol (EVOH). To further improve the barrier properties, the EVOH-layer may e.g. be combined with a layer of vapour deposited metal oxides. Such metal oxide layers may include all metal oxide layers known to the skilled person and which are suitable for achieving a barrier effect with respect to light, vapour and/or gas. Especially preferred are metal oxide layers based on aluminium, iron or copper, and also metal oxide layers based on titanium- or silicon oxide compounds. A metal oxide layer is generated, by way of example, by vapour deposition of metal oxide on a plastics layer, as for example an oriented polypropylene film.

To obtain a more easily recyclable and more sustainable packaging laminate, attempts have been made to replace the Al-foil of the applicants well-known packaging laminate, see FIG. 1, by an EVOH-layer. The replacement of Al with EVOH barrier may result in up to 30% reduction of the carbon footprint. However, unexpectedly the obtained recyclable packaging laminate did not work in combination with the half-cut method and the opening arrangement displayed a very poor opening performance.

Thus, although a recyclable packaging laminate is desirable, a disadvantage of simply replacing the Al-foil by the alternative barrier layers is that the obtained laminate packaging material is no longer suitable for opening arrangements using the half-cut method and leads to a poor sealing performance.

An object of the present invention is to provide a container made in a recyclable packaging laminate being suitable for use with the half-cut method.

### SUMMARY OF THE INVENTION

The present invention is defined by the appended claims and in the following:

In a first aspect, the invention relates to a container for holding a pourable food product, the container comprising a laminated packaging sheet material which is folded to form said container. The sheet material comprises a cut extending partway through the sheet material from an outside surface thereof, along which cut the sheet material is configured to be broken along the cut during a first opening of the container revealing an opening in the container.

The skilled person will understand that the terms laminated packaging sheet material, laminate, sheet material and laminate sheet material are synonyms.

The sheet material (50) comprises as layers of a layer sequence, in a direction from an external side to an internal side of the sheet material, a paperboard layer, a polymeric intermediate layer and a polymeric barrier layer. The internal side is the side facing the inside of the container. A polymeric barrier layer is a polymer layer that is gas proof, in particular that is oxygen proof.

In an embodiment of the container according to the first aspect of the invention, the polymeric intermediate layer, is made of a material comprising low density polyethylene (LDPE), linear low density polyethylene (LLDPE), metallocene linear low density polyethylene (mLLDPE), medium density polyethylene (MDPE), high density polyethylene (HDPE), polypropylene (PP) or any blend thereof.

LDPE is a low density polyethylene with a density between 0.910 and 0.925 g/cm³.

LLDPE is a linear low density polyethylene with a density between 0.915 and 0.925 g/cm³.

MDPE is a medium density polyethylene with a density between 0.926 and 0.935 g/cm³.

HDPE is a high density polyethylene with a density greater or equal to 0.936 g/cm³.

In an embodiment of the container, the polymeric intermediate layer is made of a material having a density equal to or over 0.926 g/cm³. In another embodiment of the container, the polymeric intermediate layer is made of a material having a density equal to or over 0.936 g/cm³. In another embodiment of the container, the polymeric intermediate layer is made of a material having a density equal to or over 0.941 g/cm³.

In an embodiment of the container, the polymeric intermediate layer may comprise 20% to 80% HDPE; 30% to 70% HDPE or 40% to 60% HDPE.

In an embodiment of the container, the polymeric intermediate layer may comprise 20% to 80% LDPE; 30% to 70% LDPE or 40% to 60% LDPE.

In an embodiment of the container, the polymeric intermediate layer may comprise 20% to 80% LLDPE; 30% to 70% LLDPE or 40% to 60% LLDPE.

In an embodiment of the container, the polymeric intermediate layer may comprise 20% to 80% mLLDPE; 30% to 70% mLLDPE or 40% to 60% mLLDPE.

In an embodiment of the container, the polymeric intermediate layer may comprise 20% to 80% MDPE; 30% to 70% MDPE or 40% to 60% MDPE.

In an embodiment of the container, the polymeric intermediate layer may comprise 20% to 80% PP; 30% to 70% PP or 40% to 60% PP.

In an embodiment of the container, the polymeric intermediate layer may consist of a blend of HDPE and LDPE.

In an embodiment of the container, the polymeric intermediate layer may consist of a blend of HDPE and LLDPE.

In an embodiment of the container, the polymeric intermediate layer may consist of a blend of HDPE and mLLDPE.

In an embodiment of the container, the polymeric intermediate layer may consist of a blend of HDPE and MDPE.

In an embodiment of the container, the polymeric intermediate layer may consist of a blend of MDPE and LDPE.

In an embodiment of the container, the polymeric intermediate layer may consist of a blend of LDPE and LLDPE.

In an embodiment of the container, the polymeric intermediate layer may consist of a blend of LDPE and mLLDPE.

In an embodiment of the container, the polymeric intermediate layer may consist of a blend of PP and LDPE, PP and LLDPE, PP and mLLDPE, PP and MDPE or PP and HDPE.

In an embodiment of the container, the polymeric intermediate layer may consist of a blend HPDE and two other polymers chosen from LDPE, PP, MDPE, LLDPE and mLLDPE.

In an embodiment of the container, the polymeric intermediate layer may consist of a blend HPDE, LLDPE and LDPE

In an embodiment of the container, the cut (or partial depth cut) may extend into the sheet material to a depth (Dc) being within the range of 10% to 95% of the total thickness (D) of the sheet material. In another embodiment, Dc may be between 20% and 90% of D. In another embodiment, Dc may be between 20% and 80% of D. In another embodiment, Dc may be between 30% and 70% of D. In another embodiment, Dc may be between 70% and 95% of D.

In an embodiment of the container, the cut may extend into the sheet material at least partly through the paperboard layer, and at most partly into the polymeric intermediate layer. In other words, the cut does not extend through the polymeric barrier layer.

A person skilled in the art may verify the depth of the cut with known methods, for example by slicing (for example with a microtome) the sheet material structure orthogonally to the plane of the sheet material and through the cut (or partial depth cut), such that the depth of the cut (or partial depth cut) and through which layer it extends, may be evaluated with a microscope.

In an embodiment of the container, the container may further comprise an opening arrangement, the opening arrangement configured such that a section of the sheet material defined by the cut is pushed or pulled during the first opening of the container, such that the sheet material is ruptured along the cut, yielding an opening in the container is obtained. The opening has a periphery corresponding to the cut

In an embodiment of the container, the cut may extend into the sheet material substantially orthogonal to the outside surface of the sheet material.

In an embodiment of the container, the polymeric intermediate layer may be in direct contact with the paperboard layer. In another embodiment of the container, the polymeric intermediate layer may be in direct contact with the polymeric barrier layer. In another embodiment of the container, the polymeric intermediate layer may be in direct contact both with the paperboard layer on one side and with the polymeric barrier layer on its other side. Here the skilled person will understand that direct contact means that there is no layer between the polymeric intermediate layer and the paperboard layer and/or between the polymeric intermediate layer and the polymeric barrier layer.

In an embodiment of the container, the sheet material (50) may further comprises a vacuum deposited layer between the polymeric barrier layer (32) and the polymeric intermediate layer (20). In an embodiment of the container, the polymeric barrier layer may be made of EVOH.

In an embodiment of the container, the sheet material may further comprise as layers of a layer sequence, in a direction from an external side to an internal side, after the polymeric barrier layer a Tie layer and a moisture barrier layer.

A tie layer may also be termed an adhesive layer.

In another embodiment of the container, the sheet material may further comprise as layers of a layer sequence, in a direction from an external side to an internal side, after the polymeric barrier layer, a Tie layer and two moisture barrier layer.

In an embodiment of the container, at least one of the moisture barrier layers may comprise mLLDPE.

In an embodiment of the container, at least one of the moisture barrier layers may comprise a blend of mLLDPE and LDPE.

In an embodiment of the container, one of the moisture barrier layers may comprise mLLDPE and the other comprises LDPE.

In another embodiment of the container, the sheet material may further comprise as layers of a layer sequence, in a direction from an external side to an internal side, after the polymeric barrier layer made of EVOH, a Tie layer, an mLLDPE layer and an LDPE layer.

In another embodiment of the container, the sheet material may further comprise as layers of a layer sequence, in a direction from an external side to an internal side, after the polymeric barrier layer made of EVOH, a Tie layer, an LDPE layer, and an mLLDPE layer.

In a second aspect, the invention relates to a blank for making the container according to the first aspect of the invention.

In an embodiment of the blank according to the second aspect of the invention, the blank may comprise a cut extending partway through the sheet material from an outside surface thereof, along which cut the sheet material is configured to be broken along the cut during a first opening of the container revealing an opening in the container.

In a third aspect, the invention relates to a laminated packaging sheet material for a container according to the first aspect of the invention, the sheet material comprising as layers of a layer sequence, in a direction from an external side to an internal side of the sheet material, a paperboard layer, a polymeric intermediate layer, a polymeric barrier layer and a moisture barrier layer, wherein the polymeric intermediate layer is made of a HDPE-LDPE blend, and the moisture barrier layer comprises mLLDPE.

In an embodiment, the sheet material may consist of the layers of FIG. 8.

### SHORT DESCRIPTION OF THE DRAWINGS

In the following description this invention will be further explained by way of exemplary embodiments shown in the drawings:

FIG. 1 is a cross-sectional view of a laminate known in the art.

FIG. 2 is a fragmentary top plan view of a top closure obturating panel of a liquid packaging container of gable-top, slant-top or flat-top character, prior to application of a pour spout fitment thereto.

FIG. 3 is an underneath, fragmentary perspective view of the panel after opening of the container, pusher blades of a plunger of a pour spout fitment being also seen.

FIG. 4 is a perspective view from above of a gable-top container with the pour spout fitment applied thereto.

FIG. 5 is a cross-sectional view of a first example of the laminate of the present invention.

FIG. 6 is a cross-sectional view of a second example of the laminate of the present invention.

FIG. 7 is a cross-sectional view of a third example of the laminate of the present invention.

FIG. 8 is a cross-sectional view of a fourth example of the laminate of the present invention.

FIG. 9 is a table of the result of leakage testing.

FIG. 10 is a table of the result of push through testing.

It should be understood that the drawings are not intended to limit the invention to the subject-matter depicted in the drawings.

In the drawings, like reference numerals have been used to indicate common parts, elements or features unless otherwise explicitly stated or implicitly understood by the context.

### DETAILED DESCRIPTION OF THE INVENTION

In the following embodiments of containers will be described in more detail with reference to the drawings. However, it is specifically intended that the invention as defined in the claims is not limited to the embodiments and illustrations contained herein but includes modified forms of the embodiments including portions of the embodiments and combinations of elements of different embodiments as come within the scope of the claims.

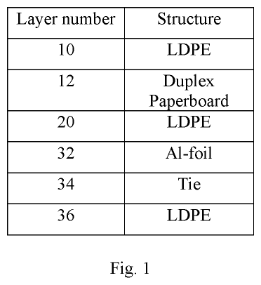

FIG. 1 shows a schematic cross-sectional view of a known laminate comprising as layers of a layer sequence, in a direction from an external side to an internal side of the sheet material, a first moisture barrier 10 made of LDPE, a Duplex paperboard layer 12, a polymeric intermediate layer 20 made of LDPE, an oxygen barrier layer 32 made of Alu foil, a tie layer 34 and a moisture barrier layer 36 made of LDPE.

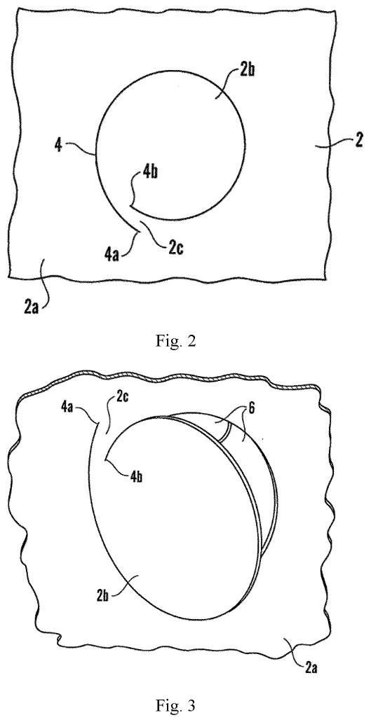

The laminate structure of FIG. 1, may be used to make packaging, using the half-cut method to form an opening arrangement. A typical opening arrangement is illustrated in FIG. 2-4.

Referring to the drawings, the top closure obturating panel 2 of the container 1 is formed with the half-cut method, i.e. formed with a partial depth cut 4 through the outermost moisture barrier layer 10 and at least part of the paperboard layer 12, but not penetrating the oxygen barrier layer 32, of laminate packaging material consisting, progressing from the exterior of the container to the interior thereof, of at least a moisture barrier 10 layer, a paperboard layer 12, an oxygen barrier layer 32, a tie layer 34 and a moisture barrier layer 36. The partial depth cut has been formed in the laminate material before filling of the container 1, for example during cutting of the container blank from a web of the laminate material. The knife used for forming the partial depth cut 4 is of a corresponding shape and size to that cut 4. As can be seen from FIG. 1, the partial depth cut 4 is in the form of an open loop of which one end 4a is at a greater distance from a central zone of the loop 4 than is the other end 4b thereof. The open loop 4 may be such that, progressing from the end 4b thereof, the loop is of a constant radius through about 270°, where that part-circle then merges into a part-circle of a larger radius for about 110° to the end 4a, so that the ends 4a and 4b overlap each other.

Following filling and top-sealing of the container 1, there is then applied to the top surface of the panel 2a pour spout fitment 3 consisting of a flanged pour spout 5, a screw cap 7 on the pour spout, and a plunger cooperating with the screw cap 7 and the pour spout 5 in such manner that, upon unscrewing of the screw cap 7 from the pour spout 5, the plunger is simultaneously displaced axially inwards and rotates about its own axis relative to the container 2. At its inner end, the plunger is formed with arcuate pushing blades 6, which thereby turn about the axis of the fitment 3 while advancing axially inwards and so cause the laminate material of the panel 2 to fracture along the partial depth cut 4 such that an encircling portion 2a of the panel 2 and an encircled portion 2b of the panel 2 within the loop 4 separate from each other along the loop 4, but remain interconnected by way of an intermediate portion 2c of the panel 2 extending through between the ends 4a and 4b of the loop.

To obtain a recyclable packaging laminate, attempts have been made to replace the Al-foil of the applicants well-known packaging laminate, see FIG. 1, by an EVOH-layer. However, these new laminate structures were shown not to be suitable for use with all types of opening arrangement, especially with the half-cut method. With this method, the opening arrangement does not open as it should, for example by not opening fully, which does not allow the user to pour liquids as intended, by ripping the packaging in un unintended way that may result in compromising the sealing properties of the packaging, or even leakage.

It is an object of the invention, to modify this laminate structure in order to obtain a laminate structure that will be suitable for use combined with the half-cut method, yielding a half-cut opening arrangement and will be suitable for use in containers for holding pourable food product.

This objective is achieved by introducing a polymeric intermediate layer 20 between the paperboard layer 12 and the polymeric barrier layer 32. This intermediate polymeric layer 20 comprises or consists of LDPE, LLDPE, mLLDPE, MDPE, HDPE, PP or any blend thereof.

From the present invention it is surprisingly seen that an improved well-functioning opening performance is provided by introducing the polymeric intermediate layer 20 comprising LDPE, LLDPE, mLLDPE, MDPE, HDPE, PP or any blend thereof.

A polymeric layer comprising LDPE, LLDPE, mLLDPE, MDPE, HDPE, PP or any blend thereof was expected to increase the elastic properties of the laminate structure.

Further, it is seen that an even more improved opening performance is provided with a polymeric intermediate layer 20 comprising HDPE providing a well-functioning opening performance.

It should be understood that a well-functioning opening performance should be understood as being not to stiff or hard nor to elastic to open.

Suitable examples of HDPE are CG8410 from Borealis (0.941 g/cm³), CG8410 from Borealis (0.962 g/cm³), Dowlex 2006G from Dow (0.961 g/cm³), Trucoat MC2004 from Westlake (0.946 g/cm³), Rigidex HD6070FA (0.960 g/cm³).

Suitable examples of LDPE are CA 8200 from Borealis (0.920 g/cm³), LDPE PT 7007 from Dow (0.918 g/cm³), LDPE LD 258 from ExxonMobil (0.919 g/cm³), 19N430 from INEOS (0.920 g/cm³).

Preferably the blend comprises between 20 and 100% HDPE, preferably between 25% and 75% HDPE, preferably between 40% and 60% HDPE.

Preferably the blend comprises between 0 and 80% LDPE, more preferably between 25% and 75% LDPE, more preferably between 40% and 60% LDPE.

Preferably the blend is a blend of LLDPE, mLLDPE, MDPE, HDPE, or PP with LDPE.

HDPE and blends of polymers having a density over 0.941 g/cm³ have shown a surprisingly good combination of properties with regards to ease of production and opening performance. Polymers and blends having a high crystallinity have also been found to be advantageous.

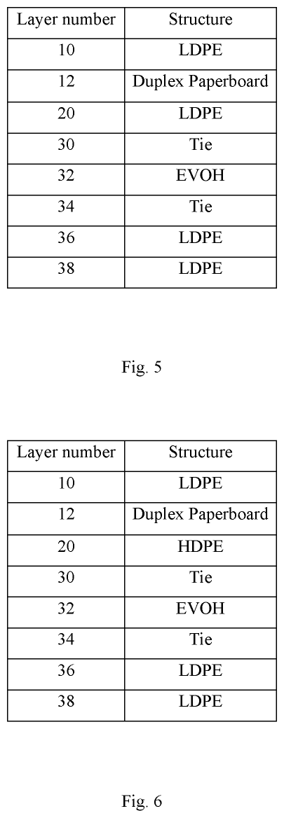

The present invention is a paperboard-based container 1 for holding a pourable food product, the container 1 comprising a laminated packaging sheet material 50 cut in a blank which is folded to form said container 1, the sheet material 50 comprising as layers of a layer sequence, in a direction from an external side to an internal side of the sheet material 50, a paperboard layer 12, a polymeric intermediate layer 20 and a polymeric barrier layer 30, 32, 34, as illustrated in FIG. 5-8.

The sheet material 50 further comprises a cut 4 extending partway through the sheet material 50 from an outside surface thereof, along which cut 4 the sheet material 50 is configured to be broken during a first opening of the container 1 revealing an opening in the container 1.

The presence of the polymeric intermediate layer 20 improves the opening performance of the container. Namely, the sheet material 50 comprising the new laminate structure is suitable for use with the known half-cut technology, i.e. in containers comprising a half-cut opening arrangement.

FIG. 5 shows a cross-sectional view of a laminate used in a first example of the inventive paperboard-based container 1, the container 1 comprising as layers of a layer sequence, in a direction from an external side to an internal side of the sheet material 50, a moisture barrier layer 10 made of LDPE, a Duplex paperboard layer 12, a polymeric intermediate layer 20 made of LDPE, a Tie layer 30, a barrier layer 32 made of EVOH, another Tie layer 34, a moisture barrier 36 made of LDPE and a further moisture barrier 38 made of LDPE.

Suitable examples of the polymer barrier layer 32 made of EVOH are EVAL E105B from Kuraray EVAL, EVAL C109B from Kuraray EVAL, EVAL F104B from Kuraray EVAL, Soarnol BG3522B from NIPPON GOHSEI.

Suitable examples of Tie are Admer NF837E from Mitsui, Admer AT3078E from Mitsui, Yparex 9408 from Yparex and Yparex 9207 from Yparex.

FIG. 6 shows a cross-sectional view of a laminate used in a second example of the inventive paperboard-based container 1, the container 1 comprising as layers of a layer sequence, in a direction from an external side to an internal side of the sheet material 50, a moisture barrier layer 10 made of LDPE, a Duplex paperboard layer 12, a polymeric intermediate layer 20 made of HDPE, a Tie layer 30, a barrier layer 32 made of EVOH, another Tie layer 34, a moisture barrier 36 made of LDPE and a further moisture barrier 38 made of LDPE.

The laminate structure according to the first embodiment worked in combination with the half cut method but did not yield an optimal opening performance. The laminate structure according to the second embodiment gave a much improved opening performance, as illustrated in FIG. 10. As a comparison, the push through force for Al containing sheet material as illustrated in FIG. 1 is typically 45-65N. Increasing the density or crystallinity of the material of the polymeric intermediate layer 20 appears to improve the opening performance.

The opening performance is evaluated on a sheet material 50 or a blank comprising a partial depth cut 4 used to form an opening arrangement, using a tension and compression test stand, a force gauge mounted on the test stand and a piston, mounted on the gauge. The sheet material 50 or blank comprising a partial depth cut 4 used to form an opening arrangement is placed under the piston. The test stand moves the gauge and the piston at a constant speed, from a position over partial depth cut 4 of the sheet material 50 to an end position, where the tip of the piston protrude 5 mm under the sheet material. The force necessary for opening the opening arrangement is measured with the gauge. If the opening arrangement does not open fully, or if it rips, the opening is noted as a failure. The percentage of opening failure and the push through force are then registered.

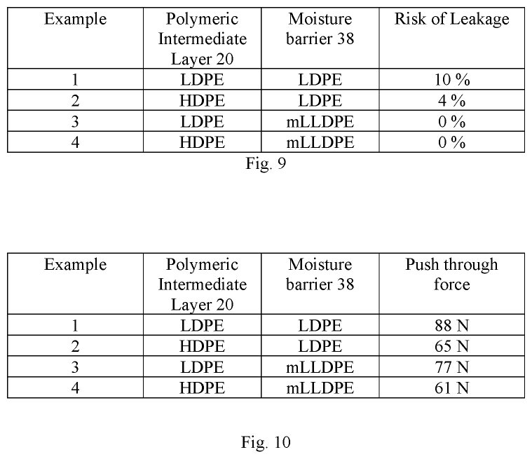

However, these containers present some risk of leakage, as illustrated in FIG. 9. It is desirable to improve the quality of the laminate to reduce the risk of leakage as well.

The risk of leakage is evaluated using what will be referred to as a dye test.

In the dye test, a large number of containers, for example 300, are cut in two halves and thoroughly rinsed. Both halves of all the containers are filled with a solvent containing a dye. Both halves are then stored for 12 h, after which a visual inspection is realized. If dye spots can be seen from the outside, then the half container is considered to leak. The risk of leakage, i.e. the percentage of leaking containers, i.e. containers showing die spots is then calculated.

This objective was achieved by replacing one of the moisture barrier layer made of LDPE 36,38 located between the polymeric barrier layer 32 and the internal side of the sheet material 50 by a moisture barrier layer comprising or made of a metallocene polyethylene (mLLDPE) layer.

Metallocene polyethylene was an unlikely candidate, because it forms a very elastic layer (up to 1200% elongation at break) and was initially ruled out as it was expected that it would reduce the opening performance of the opening arrangement.

In addition to ethylene, the mLLDPE may advantageously be based on C3- to C10-α-olefin as a co-monomer.

Suitable examples of mLLDPE are Queo 0210 from Borealis, Queo 1019 from Borealis, Elite 5800G from Dow, Affinity PT 1451G1 from Dow, Exceed 0019XC from ExxonMobil, and Eltex PF1315AA from INEOS.

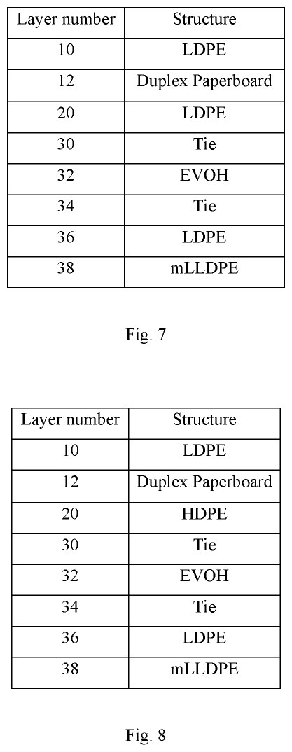

FIG. 7 shows a cross-sectional view of a laminate used in a third example of the inventive paperboard-based container 1, the container 1 comprising as layers of a layer sequence, in a direction from an external side to an internal side of the sheet material 50, a moisture barrier layer 10 made of LDPE, a Duplex paperboard layer 12, a polymeric intermediate layer 20 made of LDPE, a Tie layer 30, a barrier layer 32 made of EVOH, another Tie layer 34, a moisture barrier 36 made of LDPE and a further moisture barrier 38 made of mLLDPE.

FIG. 8 shows a cross-sectional view of a laminate used in a fourth example of the inventive paperboard-based container 1, the container 1 comprising as layers of a layer sequence, in a direction from an external side to an internal side of the sheet material 50, a moisture barrier layer 10 made of LDPE, a Duplex paperboard layer 12, a polymeric intermediate layer 20 made of HDPE, a Tie layer 30, a barrier layer 32 made of EVOH, another Tie layer 34, a moisture barrier 36 made of LDPE and a further moisture barrier 38 made of mLLDPE.

The laminate structure according to the third and fourth example reduce the risk of leakage for the inventive container. It was expected that the opening performance of the laminate would be reduced by the replacement of an LDPE layer with a layer of mLLDPE since mLLDPE is more elastic. It was therefore surprising that the third and fourth embodiment show an improved combination of opening performance and risk of leakage compared to the first and second embodiment of the invention, respectively, as illustrated in FIG. 9.

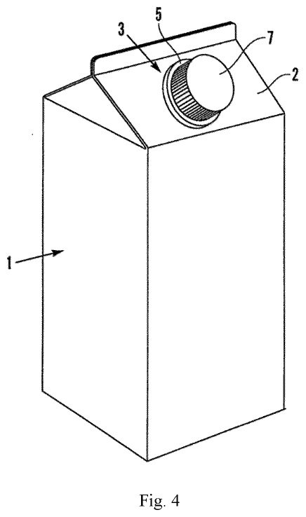

The opening of containers, as illustrated in FIG. 4, made from the sheet material of examples 1 to 4 was tested manually. Opening was registered as pass or fail. The second and fourth examples gave optimal results, i.e. all openings were registered as pass.

1. A container for holding a pourable food product, the container comprising a laminated packaging sheet material which is folded to form said container,
the sheet material comprising a cut extending partway through the sheet material from an outside surface thereof, along which cut the sheet material is configured to be broken along the cut during a first opening of the container revealing an opening in the container
the sheet material comprising as layers of a layer sequence, in a direction from an external side to an internal side of the sheet material, a paperboard layer, a polymeric intermediate layer and a polymeric barrier layer.

2. The container according to claim 1, wherein the polymeric intermediate layer, is made of a material comprising LDPE, LLDPE, mLLDPE, MDPE, HDPE, PP or any blend thereof.

3. The container according to any claim 1, wherein the polymeric intermediate layer is made of a material comprising 20% to 100% HDPE.

4. The container according to claim 1, wherein the polymeric intermediate layer is made of a material having a density of at least 0.941 g/cm³.

5. The container according to claim 1, wherein the partial depth cut extending into the sheet material to a depth being within the range of 10% to 95% of the total thickness of the sheet material.

6. The container according to claim 1, wherein the cut extends into the sheet material at least partly through the paperboard layer, and at most partly into the polymeric intermediate layer.

7. The container according to claim 1, comprising an opening arrangement, the opening arrangement configured such that a section of the sheet material defined by the cut is pushed or pulled during the first opening of the container, such that the sheet material is ruptured along the cut.

8. The container according to claim 1, wherein the cut extending into the sheet material substantially orthogonal to the outside surface of the sheet material.

9. The container according to claim 1, wherein the polymeric intermediate layer is in direct contact with the paperboard layer and with the polymeric barrier layer.

10. The container according to claim 1, wherein the sheet material further comprises a vacuum deposited layer between the polymeric barrier layer and the polymeric intermediate layer.

11. The container according to claim 1, wherein the polymeric barrier layer is made of EVOH.

12. The container according to claim 1, the sheet material further comprising as layers of a layer sequence, in a direction from an external side to an internal side, after the polymeric barrier layer a Tie layer and a moisture barrier layer.

13. The container according to claim 13, wherein the moisture barrier layer comprises mLLDPE.

14. A blank for making the container according to claim 1.

15. A laminated packaging sheet material for a container according to claim 1, the sheet material comprising as layers of a layer sequence, in a direction from an external side to an internal side of the sheet material, a paperboard layer, a polymeric intermediate layer, a polymeric barrier layer and a moisture barrier layer, wherein the polymeric intermediate layer is made of a HDPE-LDPE blend, and the moisture barrier layer comprises mLLDPE.
